(19) United States
(12) Patent Application Publication
(10) Pub. No.: US 2021/0406914 A1
(43) Pub. Date: Dec. 30, 2021

(54) SYSTEMS AND METHODS FOR VENDOR ISSUE MANAGEMENT

(71) Applicant: Venminder, Inc., Elizabethtown, KY (US)

(72) Inventor: Dana A. Bowers, Elizabethtown, KY (US)

(21) Appl. No.: 17/357,599

(22) Filed: Jun. 24, 2021

Related U.S. Application Data
(60) Provisional application No. 63/044,798, filed on Jun. 26, 2020.

(51) Int. Cl. G06Q 30/00; G06Q 10/00

(52) U.S. Cl. CPC G06Q 30/016; G06Q 10/20; G06Q 30/018

(57) ABSTRACT

Methods and systems are presented herein for managing issues with one or more vendors and/or their products or services for financial institutions.

### CROSS-REFERENCE TO RELATED APPLICATIONS

This application claims priority to and the benefit of U.S. Provisional Patent Application Ser. No. 63/044,798, filed Jun. 26, 2020, entitled “SYSTEMS AND METHODS FOR VENDOR ISSUE MANAGEMENT,” the disclosure of which is incorporated herein by reference in its entirety.

### FIELD OF THE INVENTION

This invention relates generally to systems and methods for managing client/vendor relationships. More particularly, in certain embodiments, the invention relates to systems and methods for providing vendor and agreement management.

### BACKGROUND

Financial institutions such as banks and credit unions are increasingly relying on third-party vendors to perform various important functions. While this improves efficiency and reduces cost for the financial institution, there are various risks posed by such outsourcing. A financial institution (“FI”) must establish a vendor oversight program to mitigate such risks, comply with various regulations, and pass examination by auditors. Generally, maintaining oversight of different vendors and vendor products requires a coordination of large amounts of oversight requirements, tasks, documents, results, due dates, and individuals.

The vendor management process has historically been disjointed, messy, and time-consuming. A single financial institution may have numerous vendors to manage, and there may be many individuals within a given financial institution who deal with a given vendor and must coordinate collection of documents and data regarding the corresponding vendor products. Furthermore, the terms of various contracts between a financial institution and its vendors must be carefully monitored.

Moreover, financial institutions may wish to maintain different types of information about the vendors and vendor products with which they are associated. Traditional vendor management systems allow financial institutions to maintain information according to a predetermined set of fields.

There is a need for a consolidated, efficient system for managing contracts between a financial institution and its vendors.

### SUMMARY

Methods and systems are presented herein for adding, to a vendor management system, information relating to one or more (new) vendors providing services and/or other products to the financial institution.

In one aspect, the invention is directed to method for managing one or more vendors and/or products. The method includes the step of causing to display, by a processor of an enterprise system, one or more graphical user interfaces (GUIs) associated with one or more issue management modules. The method includes the step of receiving, by the processor of the enterprise system, a first input (e.g., received via a graphical user interface widget) from a first client user (e.g., said first client user having been authorized to access the enterprise system, e.g., said first client user being one member of a network of subscribed clients), the first input comprising instructions to access an issue form. The method includes the step of receiving, by the processor of the enterprise system, (e.g., received via a graphical user interface widget) data field information related to said vendor and/or product. The method includes the step of updating, in a memory of the enterprise system, vendor and/or product information stored in association with the first client, based on the subsequent input. The issue management module is configured to track or monitor unplanned or planned events that arise with a vendor.

The subsequent input may include data field information requesting approval of closure of an issue. The subsequent input may include custom data field information related to issue severity. The subsequent input may include custom data field information related to selectable form fields or custom form fields. The first input may include instructions to access an issue form via a questionnaire module or a vendor dashboard. The first input may include instructions to access an issue form via a residual risk module. The subsequent input may include a request to display a manage issues GUI or an issue history GUI. The system may be configured to generate and send one or more email communications upon receipt of one or more triggers.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a block diagram of an example system for managing contracts between a financial institution and its vendors.

FIG. 2 is a block diagram of the example system for managing contracts between the financial institution and its vendors in accordance with an embodiment of the invention.

FIG. 3 is an example main dashboard in accordance with an embodiment of the invention.

FIG. 4 is an example vendor dashboard in accordance with an embodiment of the invention.

FIG. 5 is an example document storage page in accordance with an embodiment of the invention.

FIG. 6 is an example workflow of the system in guiding an end-user in preparing a vendor oversight report associated with one or more selected vendor products in accordance with an embodiment of the invention.

FIG. 7 is an example vendor exam preparation workspace in accordance with an embodiment of the invention.

FIG. 8 is an example workspace for collecting documents by matching collected end-user's document to a list of suggested documents in accordance with an embodiment of the invention.

FIG. 9 is an example workspace for collecting documents by prompting the end user for selection of actions for unassigned documents that have been provided by the end user in accordance with an embodiment of the invention.

FIG. 10 is an example workspace for collecting documents by prompting the end user for selection of actions for unassigned suggested documents in accordance with an embodiment of the invention.

FIG. 11 is an example workspace for preparing a collected document for the examination report in accordance with an embodiment of the invention.

FIG. 12 is an example workspace for uploading document to be attached and included in the examination in accordance with an embodiment of the invention.

FIG. 13 is an example workspace to previewing contents to be included in the examination report.

FIG. 14 is an example workspace to review vendor products in accordance with an embodiment of the invention.

FIG. 15 is an example display for viewing product review in accordance with an embodiment of the invention.

FIG. 16 is an example alert and information display in accordance with an embodiment of the invention.

FIG. 17 is an example Issue Form: Approvals GUI in accordance with an embodiment of the invention.

FIG. 18 is an example Issue Form: Severity Levels GUI in accordance with an embodiment of the invention.

FIG. 19 is an example Issue Form: Minimum Required Fields GUI in accordance with an embodiment of the invention.

FIG. 20 is an example Issue Form: Suggested Fields GUI in accordance with an embodiment of the invention.

FIG. 21 is an example Issue Form: Custom Field GUI in accordance with an embodiment of the invention.

FIG. 22 is an example Issue Form: Additional Field Management GUI in accordance with an embodiment of the invention.

FIG. 23 is an example Questionnaire Responses: Open an Issue GUI in accordance with an embodiment of the invention.

FIG. 24 is an example Questionnaire Responses: Open an Issue GUI in accordance with an embodiment of the invention.

FIG. 25 is an example Issue Management Module: Manage Issues GUI in accordance with an embodiment of the invention.

FIG. 26 is an example Vendor Dashboard: Issues GUI in accordance with an embodiment of the invention.

FIG. 27 is an example Oversight Task: Create an Issue using flag GUI in accordance with an embodiment of the invention.

FIG. 28 is an example Oversight Task: Issue Associated GUI in accordance with an embodiment of the invention.

FIG. 29 is an example Document: Create an Issue using flag GUI in accordance with an embodiment of the invention.

FIG. 30 is an example Document: Issue Associated GUI in accordance with an embodiment of the invention.

FIG. 31 is an example Assessment: Create an Issue using flag GUI workspace in accordance with an embodiment of the invention.

FIG. 32 is an example Assessment: Issue Associated GUI in accordance with an embodiment of the invention.

FIG. 33 is an example Issue Management: Manage Issues GUI in accordance with an embodiment of the invention.

FIG. 34 is an example Issue Management: Manage Issues GUI in accordance with an embodiment of the invention.

FIG. 35 is an example Issue Inventory Report GUI in accordance with an embodiment of the invention.

FIG. 36 is an example Issue Quantity Report GUI in accordance with an embodiment of the invention.

FIG. 37 is an example Issue by Vendor GUI in accordance with an embodiment of the invention.

FIG. 38 is a block diagram of an example network environment for use in the methods and systems for analysis of spectrometry data, according to an illustrative embodiment.

FIG. 39 is a block diagram of an example computing device and an example mobile computing device, for use in illustrative embodiments of the invention.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### Definitions

Client: Organization that uses the provided software described herein.

Purchase Plan: Outlines a client's access to modules within the provided software.

Administrator: A client user that has access to the admin panel and system settings that ‘controls’ how the client's provided software account functions.

Issue Management: A software module provided to the client.

Issue Owner: A (client) user who created or is ultimately responsible for overseeing the issue.

Questionnaire: A software module provided to the client that allows questions to be sent to internal and external recipients.

Recipient: A user or user system who receives/needs to complete the questionnaire generated via the provided software described herein.

### DETAILED DESCRIPTION

Methods and systems are presented herein for assessing risk associated with a vendor providing services and/or other products to a financial institution, for preparation of associated risk assessment reports or vendor oversight reports, and for maintenance of a plurality of risk assessment reports associated with a plurality of vendors.

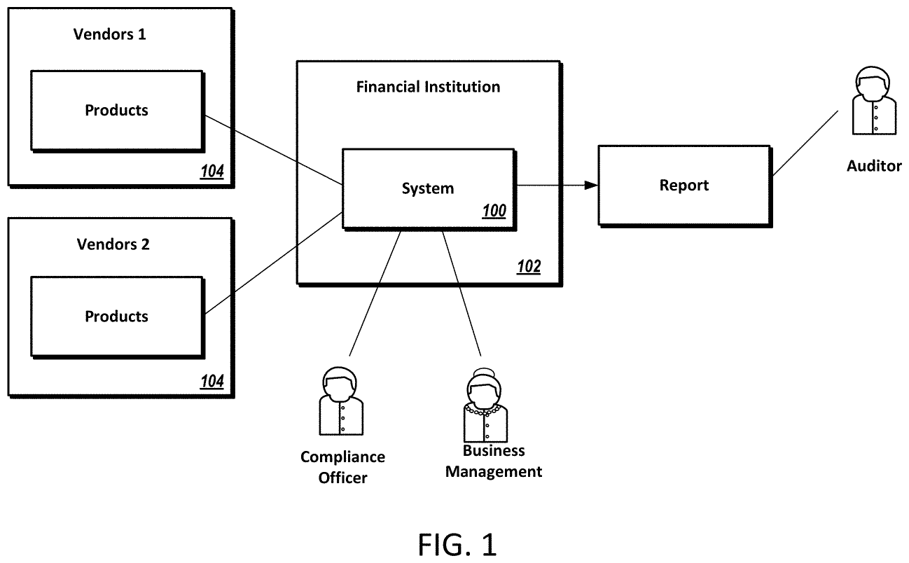

FIG. 1 is a block diagram of an example system 100 to assist financial institutions 102 to manage vendors 104 in accordance with an embodiment of the invention. In some implementations, the system 100 provides guided workflow to i) manage contracts with a given vendor 104, to provide a guided workflow to assist the financial institution 102 to prepare for an compliance or contract audit examination, ii) provide a rating system of the vendors 104 and their products and services, iii) provide a risk-assessment rating-system for the vendors 104, and iv) provide mechanisms for collaboration, the tracking of communication, and document storage.

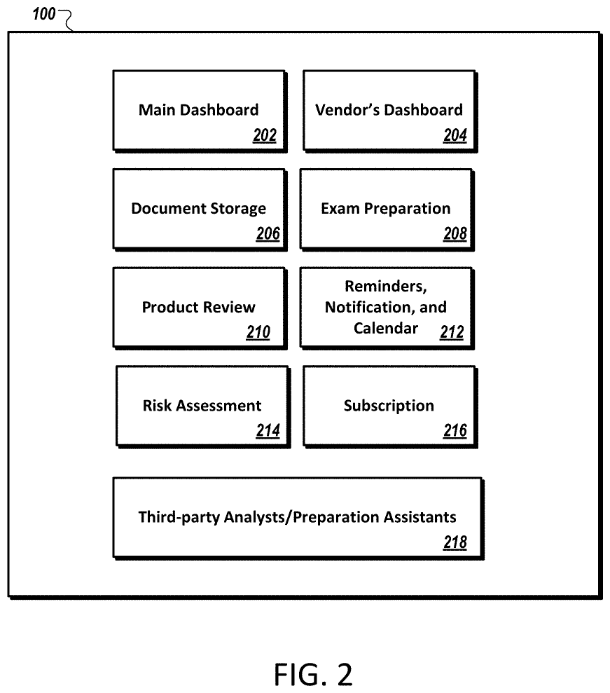

FIG. 2 is a block diagram of the example system 100 for managing contracts between the financial institution and its vendors in accordance with an embodiment of the invention. The system 100 may include a main dashboard 202 for managing actions associated with a given vendor 104 and to track such actions. The system 100 may include a vendor dashboard 204 to view and manage products and vendors associated with a given financial institution. The system 100 may include a document storage page 206 to view and manage documents associated with the vendors and their products. In some implementations, the document storage page 206 may be accessible via the main dashboard 202 and the vendor dashboard 204.

The system 100 may include a reminder, notification, and/or calendar function 212. The function 212 may manage and store a list of dates associated with expiration of a given document or contract as well as a list of personal reminders provided by the end-users. The function 212 may display such reminders in a calendar display. The function 212 may send notifications to the end-user based on pre-defined rules associated with an examination. The rules may be related to the expiration date of a given product or agreement, a scheduled examination, a risk-assessment evaluation, and etc.

The function 212 may include an alert and/or information feed (e.g., new documents uploaded, new reviews added, status update on a given examination or preparation process, etc.). The alert may include a progress bar to indicate a given end-user progress with a given task.

The alert may include an experience bar to indicate a given end-user usage level associated with the various functions of the system 100.

The system 100 may include a risk-assessment module 214 to guide an end-user in assigning a risk rating for a given vendor and/or product. The risk-rating may be utilized as part of the reporting of the compliance and/or contract audit examination. In some implementations, the risk rating may be used to determine the types of information and the types of documents to include in the examination report.

The system 100 may include a subscription module 216. The subscription module 216 may manage and maintain usage by the end-user of the various system components (e.g., 202, 204, 206, 208, 210, 212, and 214) for a given financial institution. The system 100 may monitor the end-user's action, such as the usage of complimentary tools and document storage, purchases of additional tools and document storage, purchases of enterprise features, among others.

In some example embodiments, the system may include one or more modules for executing, providing and/or causing to display one or more graphical user interfaces (GUIs) and/or widgets. The GUIs and/or widgets may include a vendor profile widgets for, among other things, managing vendor profiles; oversight grid widgets for, among other things, providing grid-based oversight of oversight requirements; task widgets for, among other things, managing tasks associated with oversight requirements; oversight management widgets for, among other things, managing tasks and oversight requirements associated with vendors and/or vendor products; document widgets for, among other things, managing documents associated with tasks; administrator widgets for, among other things, managing users; dashboard widgets for, among other things, managing outstanding tasks and vendor products associated with users; and reports widgets for, among other things, generating status, task and/or vendor reports.

In some example embodiments, data associated with vendors (e.g., vendor management information), which is used by the GUIs and/or widgets, may be stored in a memory of the system 100 or of a client computing device associated with the system 100. In some example embodiments, the system 100 is an enterprise system with which one or more enterprise client computing devices are connected. The GUIs and/or widgets are described in further detail below.

Main Dashboard

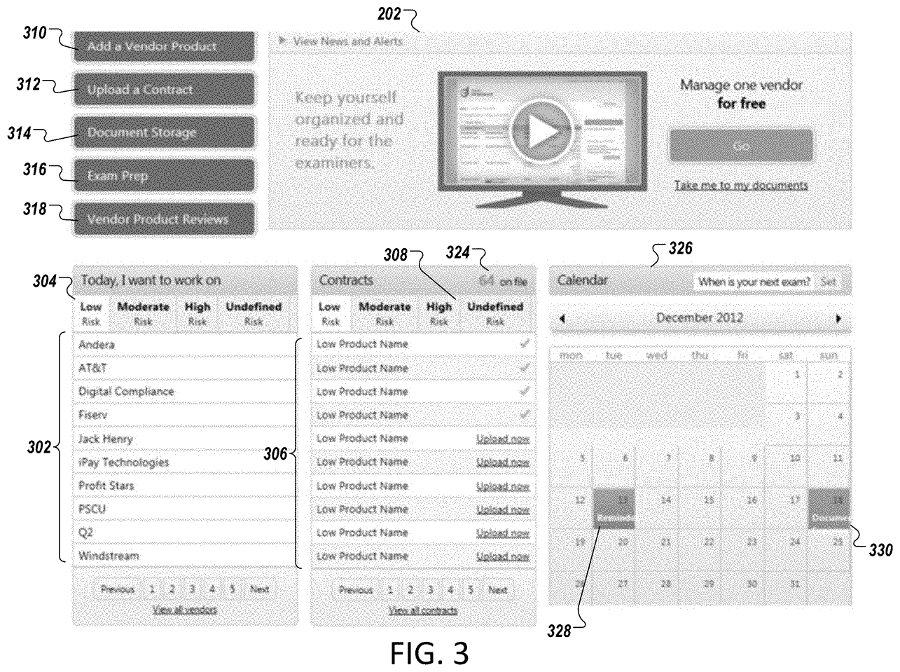

FIG. 3 is an example main dashboard 202 in accordance with an embodiment of the invention. The main dashboard 202 may be used to initiate the various functions, as described in relation to FIG. 2. The main dashboard 202 may display a vendor list 302, which may be organized and filtered by a vendor's risk level 304 (e.g., low, medium, high, or undefined/unknown). The main dashboard 202 may display a contract list 306, which may also be organized and filtered by risk levels 308. The main dashboard 202 may display a number of contracts on file (324), such as those stored in the document storage 206.

The main dashboard 202 may include a calendar 326 that displays reminder dates 328 and expiration dates 330 of contracts, of risk assessment of vendors and/or products, as well as of upcoming examinations. In some implementations, the calendar 326 may include dates in which notifications will be sent by the system. In some implementations, the calendar 326 may only display the expiration dates for documents that are uploaded by the end-user.

In some implementations, upon selecting a date in the calendar 326, the system 100 may prompt the end-user to create a reminder (e.g., for email communication, SMS-message, and other methods of notification accessible to and specified by the end-user). The system 100 may display a content of a reminder when the end-user hovers the cursor thereover. The calendar may be a part of the reminders, notification, and calendar function 212. The alerts and reminders of the calendar 326 may be employed to notify the end-user of upcoming critical dates (e.g., renewal date). The notification may be generated based on the date of the given activity having met an alert condition (e.g., exceeding a date threshold in relation to the critical date).

The main dashboard 202 may include a function to add a vendor product (310), a function to upload a contract associated with a given product (312), a function to manage stored documents (314), a function to prepare for an examination (316), and a function to review and manage reviews for a given vendor products (318).

The main dashboard 202 may be displayed to the users upon login to the system 100.

In some implementations, when adding a new vendor product (310), the system 100 may present the end user with a list of products. The list may include all products associated to the financial institution, including those that are not currently being managed by any of the end-user of that institution as well as those that do not have a contract loaded. The list of products may be maintained within a database that is managed by the system 100.

When adding a new vendor product, the system 100 may present the end-user with a list of questions associated with the product. The questions may include a request for the vendor name, the product name, the product type, and a risk level. The risk level may be defined as low, medium, high, and undefined (as corresponding to the risk level 304). Alternatively, the risk level may be an input from the risk-assessment module 214.

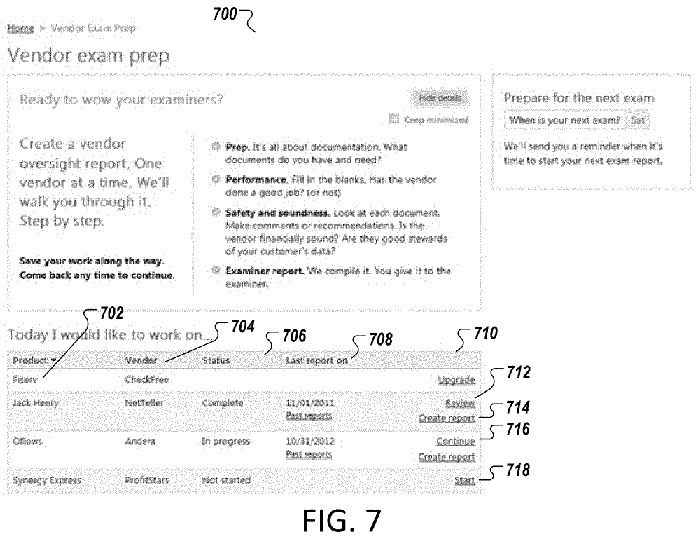

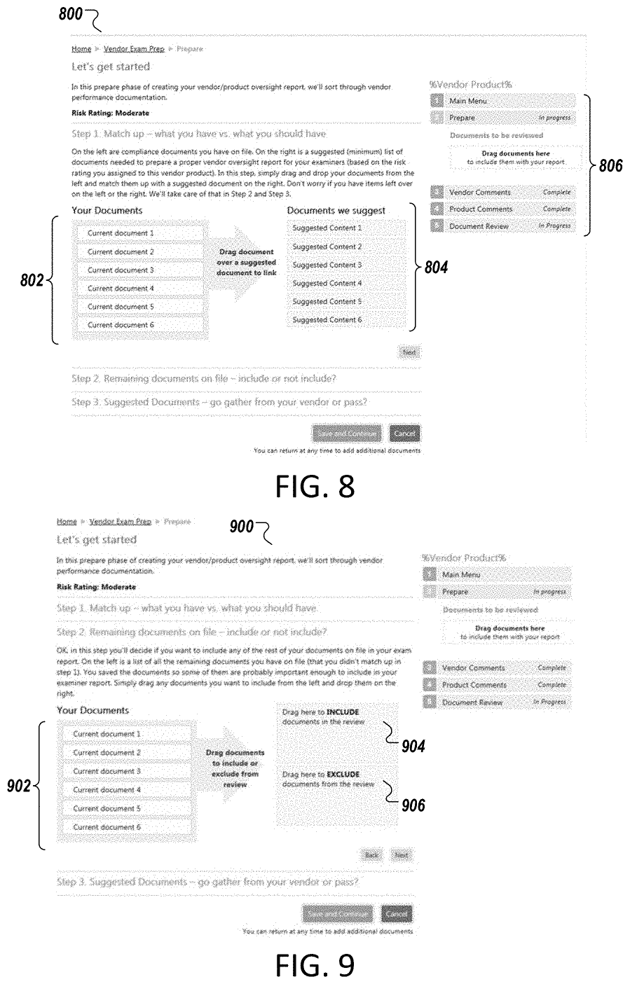

In some implementations, the risk-levels 304, 308 may be used to determine a suggested document 320 (see—see FIG. 8) in the examination-preparation area 322 (not shown—see FIGS. 7-13). Once the vendor product is added, the system 100 may present the end-user with a notification that the product has been added. In the notification, the system 100 may include a link or a selection that allows the end-user to upload a contract associated with the added vendor product. The system may also provide a link or selection to add a collaborator or to add contact information of the vendor.

In some implementations, the system 100 allows more than one person to interact with a vendor. The collaboration function allows the system 100 to receive information from the end-user about co-workers or other people in the end-user's organization that may perform actions or provide reviews for a given vendor and/or vendor product. In some implementations, the collaborator may perform any of the end-user's function (e.g., upload contract, add notes and reminders, save email conversation, and document events), though may not change or undo any of the actions performed by the end-users. Each of the vendor products may be assigned a different point of contact (i.e., a product manager). The system 100 may provide a search function for the end-user to determine if an added collaborator is already registered with the system 100.

In some implementations, when uploading a contract associated with a given product (312), the system 100 may prompt the end-user for a file. Multiple files may be selected and uploaded in a given instance. The system 100 may send a notification to the end-user that the contract has been uploaded and that a notification will be sent when it is ready for review. In some implementations, the contract may be transmitted to a third-party that analyzes and/or prepare the contract for review by the end-user. The system 100 may use aliases table. Examples of tools utilized by the third-party to analyze and prepare the contract are described in Appendices E and F of the U.S. Provisional Patent Application No. 61/805,066, which is incorporated by reference herein in its entirety.

Vendor Dashboard

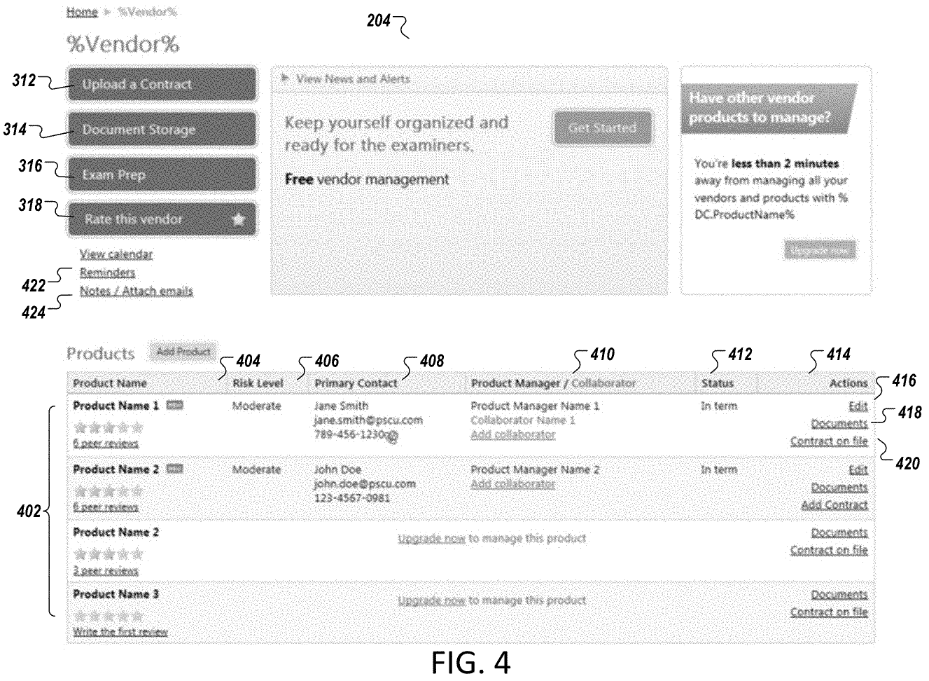

FIG. 4 is an example vendor dashboard 204 in accordance with an embodiment of the invention. In some implementations, the vendor dashboard 204 may be accessed by the end-user when the user selects a vendor from the list of vendors 302 in the main dashboard 202.

In some implementations, the vendor dashboard 204 may include the function to upload a contract associated with a given product (312), the function to manage stored documents (314), the function to prepare for an examination (316), and the function to view and manage reviews for a given vendor products (318).

In some implementations, the vendor dashboard 204 may include a list of vendor products (402) that are associated to the financial institution. The list 402 may include, for example, but not limited to, products that are currently being managed as well as products that are yet to be assigned to a given product manager. For each of the products in the list 402, the system 100 may display a product name 404, a risk level that has been assigned to the product 406, a vendor contact information 408, an assigned product manager (of the financial institution) 410, a status indicator of the product 412, and actionable tasks 414 associated with a given product. The actionable tasks 414 may allow an end-user to edit a given product information (416), to view or manage the document associated with the given product (418), and to add a contract or edit the contract on file associated with the given product (420).

Upon a selection of a product in the list 402, the system 100 may prompt the end-user whether to assign a product-manager for the product. The prompt may further include details and information about the product, including, for example, the vendor name, the product name, the product type, and the source of the product. Upon the end user providing the information, the system 100 may provide options to allow the end-user to upload a contract, to add a collaborator, or to add contact information.

Upon a selection to edit a product (416), the system 100 may display the information about an added product (e.g., the vendor name, the product name, the product type, and a risk level), as described in FIG. 3. The system 100 may also display the vendor's contact-information and/or a list of assigned collaborators.

The system 100 may provide a selection to allow the end-user to remove collaborators from specific products.

Upon a selection to edit a contract (420) associated with a product, the system 100 may display information relating to the contract, including the status of the contract (e.g., “in-term”, “renewal negotiation”, “auto-renew”, “cancelled”, “replaced”, etc.), the contract files (which may include one or more files), the end-user that uploaded the contract, the upload date, the contract date, the contract expiration date, a list of products associated with the contract, and certain key clauses (e.g., whether the contract includes an auto-renewal clause, information relating to the number of days required for a non-renewal notice, and an auto-renewal period). The system 100 may also display information relating to the contract terms (e.g., sale price per unit, etc.), comments associated with the term (e.g., whether the contract is a service-level agreement (SLA)), the vendor signatory, the institution signatory, among others. The system 100 may provide a prompt to the end-user to edit or replace the contract.

In addition, the system 100 may take actions and set reminders. Example actions of the system 100 are summarized in Table 1.

TABLE 1

| Status | Description | Action | Email Communication |
|---|---|---|---|
| In Term | Contract has not reach | No action taken | Initiate communication |
| | expiration date | | six months from |
| | | | expiration date |
| Renewal | Financial Institution is | No action taken | Sent on the expiration |
| negotiation | working on a new contract | | date |
| | terms | | |
| Auto- | Automatically renew terms | Change the contract | Sent on the expiration |
| Renew | of the contract based on the | expiration date based | date |
| | info entered when the | on the terms loaded in | |
| | contract was loaded | the upload contract | |
| | | form | |
| Cancelled | Contract is no longer valid | All products/ | Sent on the expiration |
| | | documents associated | date |
| | | with the contract will | |
| | | also be in cancelled | |
| | | status and archived | |
| Replace | Financial Institution | Move old contract to | |
| | replacing the existing | archives/new | |
| | contract with a new one | contract starts the | |
| | | upload contract | |
| | | process over | |

In addition, upon a selection to edit a contract, the system 100 may provide guidance to the end-user depending on the various selected options. For example, if the end-user specifies “renewal negotiation” (which indicates that the end-user is currently negotiating the contract with the vendor), the system 100 may provide a message that states: “By setting a contract to renewal-negotiation, you will no longer receive notices regarding contract expiration and/or auto-renewal. Change your status when you are ready. You can either upload your new contract or cancel your existing contract.” The system 100 may also take action, such as to stop the sending of the contract expiration emails.

In another example, if the end-user specifies “auto-renew” (which indicates that the contract would auto-renew with the terms as originally provided), the system 100 may prompt the end-user for a new expiration date for the contract and a date for new reminders.

In yet another example, if the end-user specifies “cancelled” (which indicates that the contract has been canceled), the system 100 may notify the end-user that the system 100 will cancel all of the selected products, archive all of the uploaded documents, and archive all of the uploaded contracts. The system 100 may also prompt the end-user for new vendor information. The system 100 may also prompt the end-user to upload a new contract or document.

In yet another example, if the end-user specifies “replace contract” (which indicates that the end-user wishes to replace an existing contract with a new contract), the system 100 may prompt the end-user for new documents associated with the new contact. The system 100 may archive the old contract in an archived folder. The old contract may be accessible to the end-user at the document storage page 206. In some implementations, the system 100 may also sent the new document to the third-party 218 for analysis and preparation.

Still looking at FIG. 4, the vendor dashboard 204 may include features to assist the end-user in managing reminders and notes associated with the vendor product. For example, the vendor dashboard 204 may include an option to display all of the reminders (422) associated with a given vendor.

The vendor dashboard 204 may include an option to attach and view notes and correspondences (424) (e.g. electronic mail) associated with the vendor. In some implementations, the system 100 may present the information as a list that includes the dates that the note was created, a title for the note, a note type, a product name, an identifier of the end-user that created the note, a vendor name, a product name, and a note message. The list may be filed, sorted, or organized using the note title, the email information, or by the product information.

Document Storage

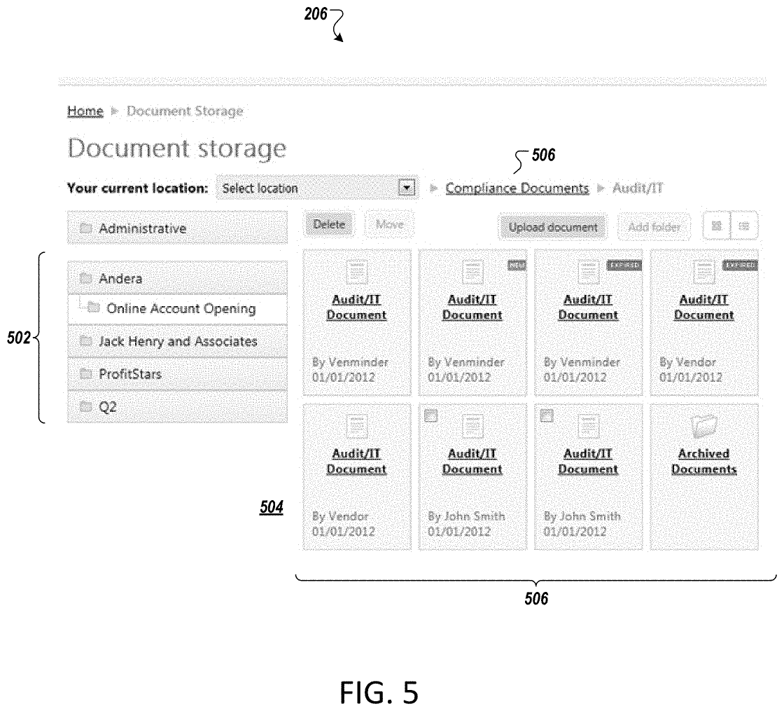

FIG. 5 is an example document storage page 206 in accordance with an embodiment of the invention. The document storage page 206 allows an end-user or product manager to view and manage documents associated with a given vendor.

In some implementations, the document storage page 206 may display a list of product managers 502 and the documents they are managing or collecting. The document storage page 206 may include a workspace 504 for managing and viewing a set of collected documents. The workspace 504 may allow the end-user to organize the set of documents in a set of vendor folders. The vendor folders may include documents and folders associated to a given vendor and vendor product.

In some implementations, the document storage page 206 may include a compliance document folder 506 to be used for the examination preparation effort. The compliance document folder 506 may include folders relating, for example, to “audit/IT”, “business continuity”, “financial”, “insurance”, “miscellaneous”, “policy”, and “product management.”

Upon a selection to upload a new document, the document storage page 206 may prompt the end-user for a file to upload, a document description, a document date, comments, and/or reminders.

The document storage page 206 may restrict the transfer of files. In some implementations, once a document has been uploaded, for example, to the compliance document folder 506, the document storage page 206 may prohibit the end-user from moving these documents to a different folder. To this end, the system 100 may require the end-user to delete the file and re-upload the file to the different folder. In some implementations, the document storage page 206 prohibits the addition of new folders to the compliance document folder 506.

As another example, only documents uploaded by the end-user may be moved by the end-user. The document storage page 206 may indicate to the end-user the documents that they have permission to move. The document storage page 206 may indicate the owner of the document.

The document storage page 206 may label the various uploaded documents. For example, in some implementations, the document storage page 206 may label documents that have been newly uploaded by the third-party 218 or by the vendor as “new”. The label may appear only during a first login session by the end-user, and the label may be removed in subsequent sessions. Other labels may include “expired.”

Exam Preparation

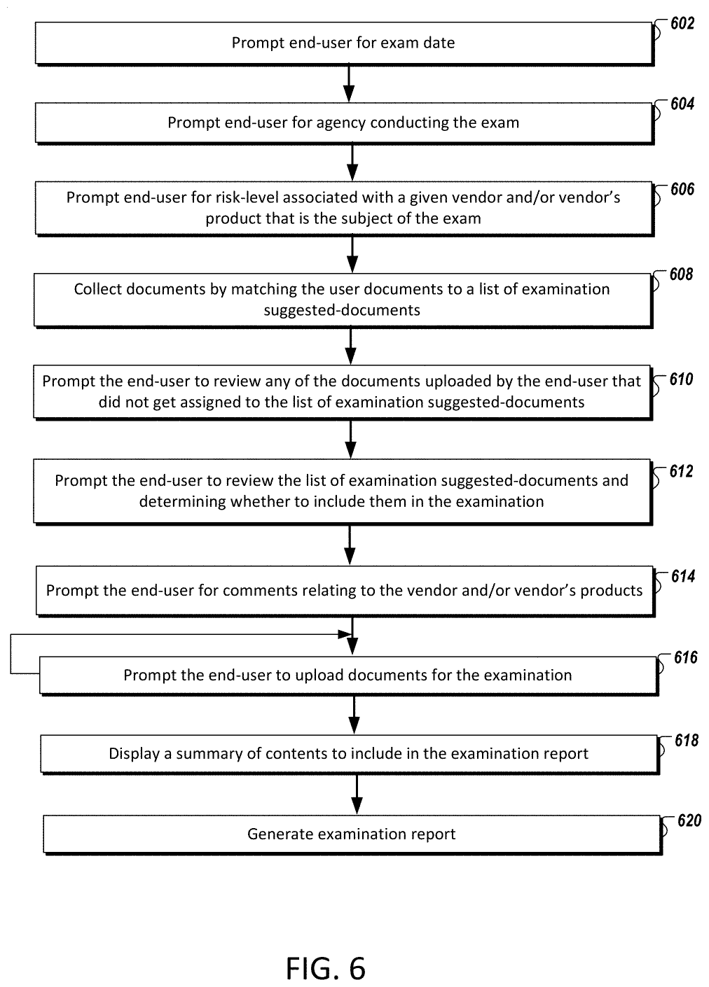

FIG. 6 is an example workflow of the system 100 to guide an end-user to prepare a vendor oversight report associated with one or more selected vendor products in accordance with an embodiment of the invention. The workflow may be referred to as “Exam Prep”. The Exam Prep may be used to assist and guide the users of a financial institutions to prepare, for example, for its annual exam with a given government agency, regulatory body, or auditing process. In some implementations, the Exam Prep may collect all of the documents that will be the subject of the examination. The Exam Prep may collect all of the notes and correspondences associated with a product. The Exam Prep may allow the end-user to review all of these documents. The Exam Prep may allow end-users to invite experts and/or collaborators to assist with the exam preparation. The Exam Prep may create or generate a report for the examiners.

In some implementations, the Exam Prep workflow may be initiated from the main dashboard 202 or the vendor dashboard 204, as described in relation to FIGS. 3 and 4.

Upon initiation of the Exam Prep workflow, the system 100 may prompt the end-user for examination information, including, for example, a date of the next regulatory exam (step 602). The system 100 may use the provided date to track the number of days remaining until the examination and to determine when notification (e.g., by email) regarding the examination may be sent. In some implementations, the system 100 may send, for example, a reminder to an end-user that created the report (and/or the product manager) 90 days before the examination. The reminder may indicate to the end-user that the report is ready for the end-user's review. The system 100 may also send a reminder, when no report has been generated, to an end-user to remind them to start a report.

In the Exam Prep workflow, in some implementations, the system 100 may prompt the user for a list of one or more agencies to be included in the examination (step 604). Examples of the agencies may include, for example, but not limited to, the Consumer Financial Protection Bureau (CFPB), Federal Deposit Insurance Corporation (FDIC), Federal Reserve System (FED), National Credit Union Administration (NCUA), and/or the Office of the Comptroller of the Currency (OCC).

In some implementations, the system 100 may also prompt the end-user for a risk-level (e.g., low, medium, high, and undefined/unknown) associated with the vendor and/or vendor product, if the information has not been provided, for which the examination is being prepared (step 606). The risk-level may be an input from the risk-assessment module 214. The system 100 may use the provided risk-level to determine suggested documents for the examination-preparation process.

FIG. 7 is an example vendor examination-preparation workspace 700 in accordance with an embodiment of the invention. The workspace 700 may display a list of products 702. For each of the products 702, the workspace 700 may display the vendor name (704), the status of the examination (706), the last reported date (708), and actionable tasks 710.

The last reported date 708 may be, for example, the last time a report was created or the last time the product was examined. The status of the examination (706) may include “complete”, “in progress”, and “not started.” A list of the examination status is shown in Table 2.

TABLE 2

| Status | Description | Action |
|---|---|---|
| Complete | All steps have been completed | Review, Preview report |
| In progress | Started but not all steps | Continue, Preview report |
| | completed | |
| Not started | No steps have been started | Start |

The actionable tasks 710 may include reviewing an examination report (712), creating a report (714), continuing a report (716), and starting a report (718).

The system 100 may save all of the work, including all of the actions taken by the end-user. To this end, the end-user can continue from another point in the examination preparation process.

Referring back to FIG. 6, in some implementations, the method 600 may include matching all of the end-user's uploaded documents to a list of examination suggested documents (step 608). The list of examination suggested documents may be a pre-defined list selected from a set of pre-defined list. The pre-defined list may be selected based on the risk-level associated with the given product or vendor subject to the examination.

FIG. 8 is an example workspace 800 for matching collected end-user's document to a list of suggested documents in accordance with an embodiment of the invention. The workspace 800 may display a list of collected documents uploaded by the end-user (802). The list may include documents collected in the compliance document folder, as described in relation to FIG. 5. The workspace 800 may display a list of suggested documents (804) for the examination. The list of suggested documents (804) may be a pre-defined list of documents that is organized by risk levels. The workspace 800 may allow the end-user to select a document from the collected list (802) and “drag and drop” it to a suggested content in the list of suggested documents (804). The action may merely associate the documents in that no files are moved.

The system 100 may display a status of the workflow (806). The status may include an indicia of the current process being performed by the end-user and a status of the other processes (e.g., complete, in-profess, or ready to start) in the workflow.

Referring back to FIG. 6, in some implementations, the method 600 may include prompting the end-user to review any of the collected documents uploaded by the end-user that was not assigned to the list of the examination suggested-documents (step 610). FIG. 9 is an example workspace 900 for prompting the end-user to review the unassigned documents 902 that has been collected to the document storage page 206, but has not been assigned in FIG. 8. In some implementations, the system 100 may prompt the end-user to identify each of the unassigned documents as either to include (904) or exclude (906) from the report/examination.

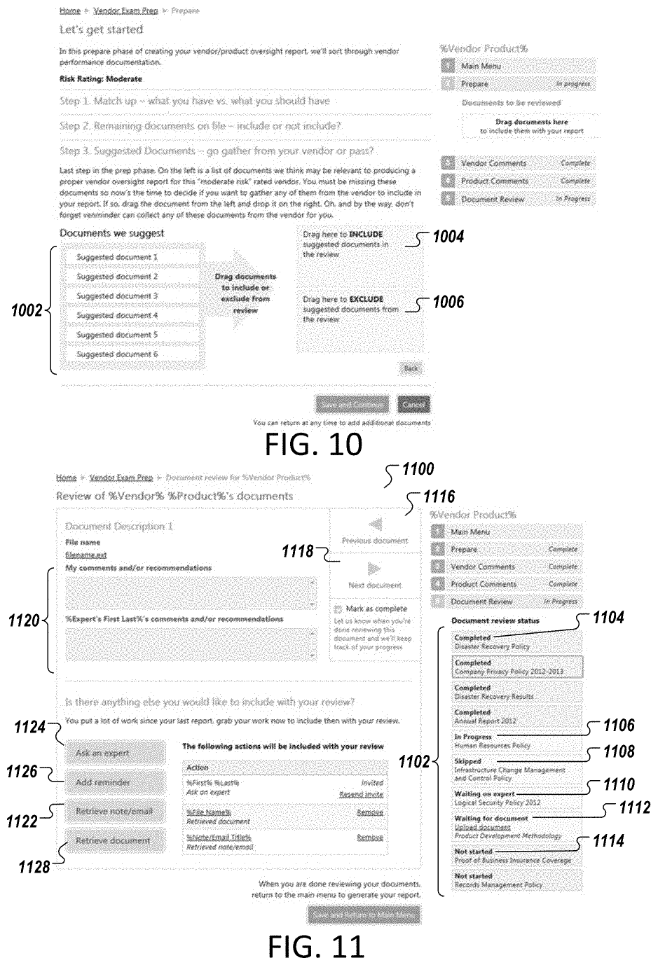

Still looking at FIG. 6, in some implementations, the method 600 may include prompting the end-user to review the list of examination suggested-documents and determining whether to include them in the examination (step 612). FIG. 10 is an example workspace 1000 for prompting the end-user to review the unassigned suggested documents 1002. The system 100 may prompt the end-user to identify each of the unassigned suggested documents as either to include (1004) or exclude (1006) from the report/examination.

Still looking at FIG. 6, in some implementations, the method 600 may include prompting the end-user to provide comments about the vendor (step 614). The comments may be in response to interrogatories, such as (i) “What has the vendor done well since your last exam date,” (ii) “What has not gone well since your exam date,” and (iii) “What actions are you going to take before your exam date.” The system 100 may also prompt the user to provide comments for each of the vendor product that is being examined.

Still looking at FIG. 6, in some implementations, the method 600 may include displaying (step 614) all of the documents that has been matched between the end-user's uploaded documents and the list of suggested documents (as described in relation to FIG. 8) as well as those documents that are marked to include (as described in relation to FIGS. 9 and 10). FIG. 11 is an example workspace 1100 for preparing the collected document for the examination report in accordance with an embodiment of the invention. The system 100 may display a status label for each of the documents. The status label may include “completed” 1104, “in progress” 1106, “skipped” 1108, “waiting for experts” 1110, “waiting for documents” 1112, and “not started” 1114. The status labels are described in further detail in table 3.

TABLE 3

| Document | |
|---|---|
| Status-Label | Description |
| Not Started | Included in exam but the user has not reviewed it |
| Waiting on expert | Expert has been invited but no response provided |
| Waiting for | Document type is included in exam but document |
| documents | has not been uploaded |
| Skipped | Viewed the document but preformed no actions |
| In Progress | Actions preformed but not marked as complete |
| Complete | Checked the box mark as complete |

In some implementations, the system 100 may provide a navigation function to allow the end-user to scroll through the various selected documents. The navigation function may include an arrow to review the previous selected document (1116) or the next selected document (1118). For each of the selected documents, the system 100 may allow the end-user to add comments (1120), to retrieve an electronic correspondence or note (1122), to invite an expert and/or collaborator to provide comments or to assist in the document preparation (1124), and/or to set reminders (1126).

Upon selection to invite a co-worker/expert (1124), the system 100 may provide a list of co-workers and/or suggested experts for the user to send a message. The system 100 may also prompt the end-user for a name, contact information, and a message to send to a co-worker and/or expert. The system 100 may accept multiple requests for comments.

The system 100 may allow each of the co-workers and/or experts to register and login. After which, the system 100 may only allow the co-worker and/or expert to view and provide comments for the vendors and/or vendor product to which they were asked for comments. The system 100 may send a notification to the end-user subsequent to a comment being provided. The system 100 may also send a notification when the co-worker and/or expert has registered to the system 100.

Upon receipt of comments from a given co-worker and/or expert, the system 100 may label the request as being complete. The system 100 may also update the Exam Prep workspace 1100 with the received solicited comments. To this end, the system 100 may provide an organized and efficient framework to request for comments from internal and external collaborators, to track such requests, and to review and utilize such comments in the examination-preparation process.

Upon selection of an input to retrieve an electronic correspondence or note (1122), the system 100 may display a list of notes and correspondences stored within the system 100. The system 100 may provide a date, a title, a correspondence type (e.g., email, notes, SMS, etc.), and an identity of the end-user and/or product manager that performed the uploaded. The system 100 may allow the end-user to filter the list based on the correspondence type.

Still looking at FIG. 11, the system 100 may allow the end-user to retrieve additional documents (1128) related to the vendor product. A selection of this input (1128) may direct the end-user to the document storage page 206, as described and shown in relation to FIG. 5. The end-user may add documents to the examination preparation process from there.

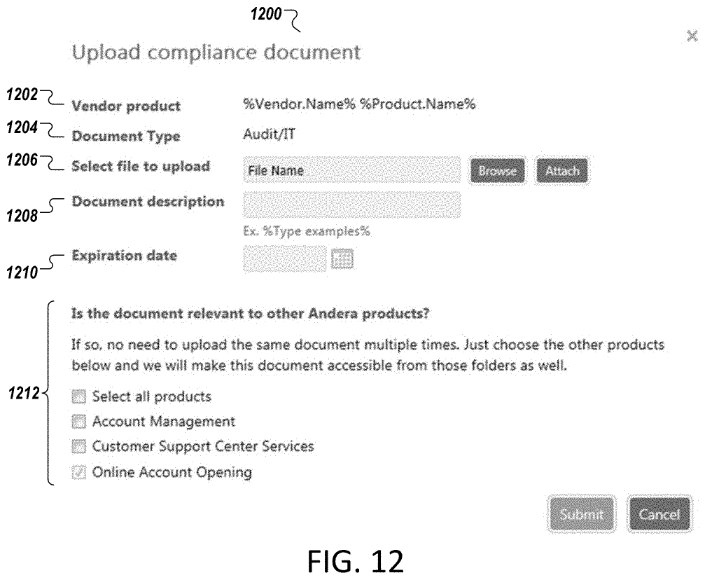

Referring back to FIG. 6, in some implementations, the method 600 may include prompting the end-user to upload documents for the examination (step 616). FIG. 12 is an example workspace 1200 for uploading document to be attached and included in the examination in accordance with an embodiment of the invention. The workspace 1200 may display the vendor product name 1202 and the document type 1204. The workspace 1200 may prompt the end-user for a file (1206), a document description (1208), an expiration date (1210), and a selection to use the document for other products (1212). The selection (1212) allows the end-user to have to upload a given document only once as the document can be applied to multiple products that may be the subject of one or more examinations. The workspace 1200 also allows the end-user to tailor comments and descriptions for each of the documents to be included in the report.

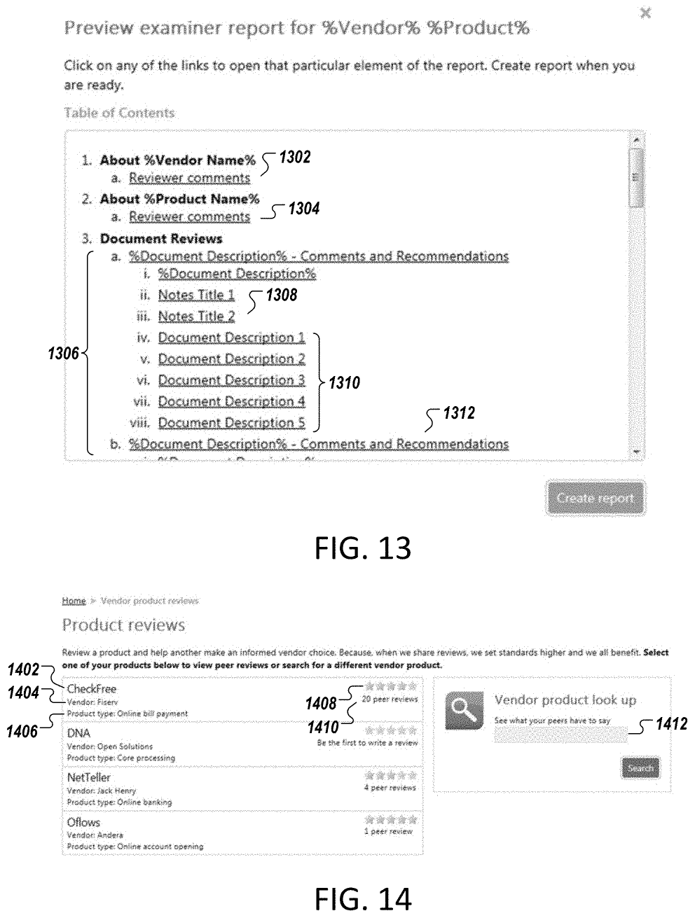

Still looking at FIG. 6, in some implementations, the method 600 may include displaying a summary of contents to include in the examination report (step 618). FIG. 13 is an example workspace 1300 to preview contents to be included in the examination report. The contents may include, for example, but not limited to, the reviewer's comments about the vendor (1302), the reviewer's comments about the products (1304), and the documents to include in the report (1306). The documents 1306 may include notes (1308), documents (1310), and comments and recommendations (1312). The system 100 may allow the end-user to preview any of the uploaded documents, comments, and notes as collected by the system 100.

Still looking at FIG. 6, in some implementations, the method 600 may include generating an examination report in accordance with an embodiment of the invention (step 620). The report may be generated, for example, as a PDF (“portable document format”) file. In some implementations, the report may be generated as a compressed file (e.g., a ZIP (archive file format) file). Upon a creation of the examination report, the system 100 may add the report to an archive section to which the end-user can later review the report. The system 100 may also update the vendor and product dashboard to indicate the recent addition of a new report as well as the status of the last instance that a report had been created. In some implementations, the system 100 may send a notification to the end-user to recommend initiating a new report (in the case of an annual report). The notification may be sent, for example, 9 months after the examination report has been generated.

Vendor Product Review

The system 100 may include a vendor product review workspace to allow the end-user to view and provide reviews/ratings for a given vendor, as described in relation to FIG. 3. In some implementations, the system 100 may display the performance rating and/or the listing of one or more performance comments received from users of the given vendor product and/or one or more corresponding products provided by one or more different vendors.

FIG. 14 is an example workspace 1400 to review vendor products in accordance with an embodiment of the invention. The workspace 1400 may display, at any given instance, a composite of multiple vendor products. The composite may include preferably four to five vendor products. Of course, any of number of vendor products may be displayed on the workspace 1400. For each of the products, the workspace 1400 may display the vendor name (1402), the product (1404), the product type (1406), a rating value 1408, and an indication of the number of reviews (1410). In some implementations, the system 100 may provide a search tool 1412. In some implementations, the system 100 may also provide a rating/review module for a given vendor.

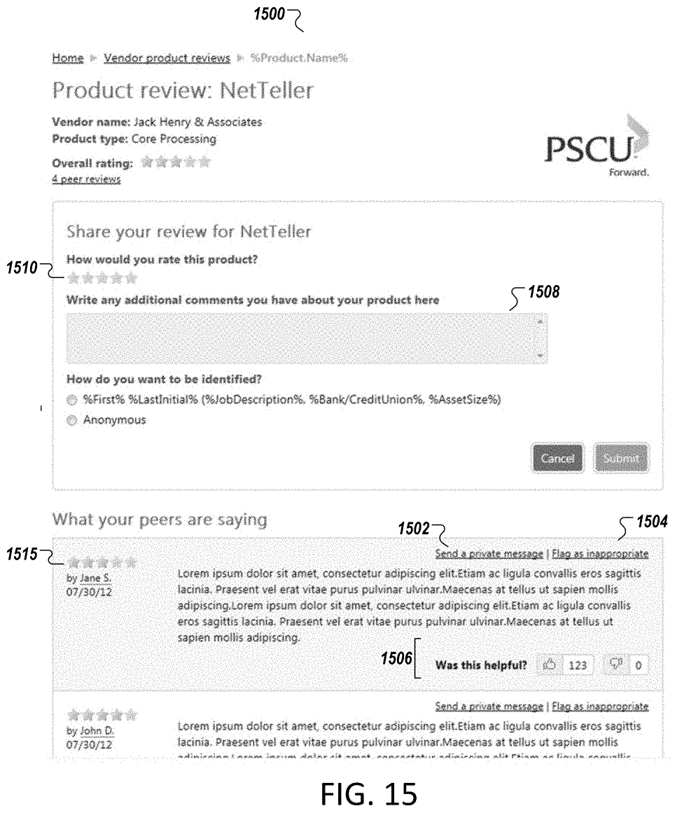

FIG. 15 is an example display 1500 for viewing product reviews in accordance with an embodiment of the invention. In some implementations, the system 100 may provide a prompt 1502 for the end-user to send a private message to the vendor or to the reviewer. The system 100 may also provide a prompt 1504 to flag the review as being inappropriate. The flag may generate a notification to a designated reviewer to determine whether the message is appropriate to display. The system 100 may also display an indicator of the number of people that flagged the review as being helpful and/or unhelpful.

The system 100 may prompt the end-user to provide a review 1508 for a given selected product. The end-user may provide a rating value 1510 (which may a star rating), comments, and identifier/contact information.

In some implementations, the display 1500 may include a listing of performance ratings (1512) received from various end-users and/or product managers of the various vendor products. The listing may be organized (e.g., ordered) on the graphical user interface according to popularity (e.g., number of “likes” received for each of the performance comments).

News and Alerts

The system 100 may include an alert and/or information feed that provides information about changes that have been made (e.g., new documents uploaded, new reviews added, and status updates for a given examination or preparation process, etc.). The alert may include a progress bar to indicate a given end-user progress with a given task.

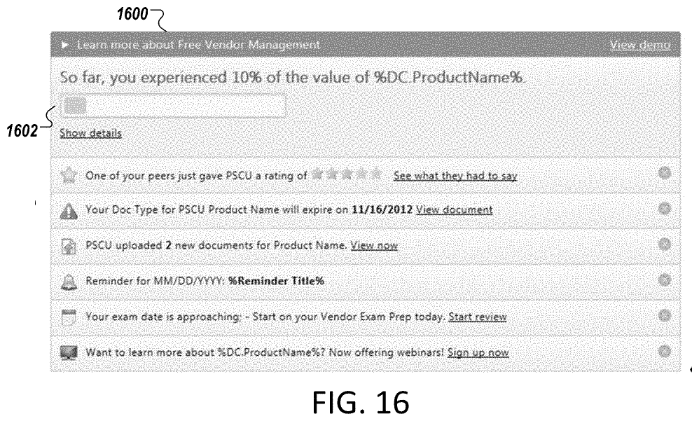

FIG. 16 is an example alert and information display 1600 in accordance with an embodiment of the invention. The display 1600 may include an experience bar 1602 that shows a given user's level of experience with the system 100. The system 100 may calculate the experience bar based on a set of tasks or functions performed by the end-user within the system 100. Each function may be assigned a function value, which may be aggregated to produce a total experience value. The experience bar 1602 may display the total experience value to the user. Examples of assigned values for a set of functions are provided in Table 4.

TABLE 4

| Function | Link | Percentage |
|---|---|---|
| Add Contract | Upload Contract | 10% |
| Add 2 Compliance Documents | Document Storage | 5% each |
| Add a vendor product | Add Vendor Product | 10% |
| Add a collaborator | Vendor Dashboard | 10% |
| Attach an email and Note | Emails and Notes | 5% each |
| Add a reminder | Reminders | 10% |
| Preform Exam Prep | Exam Prep | 20% |
| Write a review | Vendor Product Review | 10% |

Issue Management Module

In another aspect of an embodiment, system 100 provides an issue management module, designed to aid one or more clients in tracking and monitoring of unplanned or planned events that arise with one or more of their vendors.

An administrative user for a client provided with a system 100 including an issue management module may be provided with the capabilities to configure a form they wish to be used when tracking and monitoring events that may occur with their vendor(s).

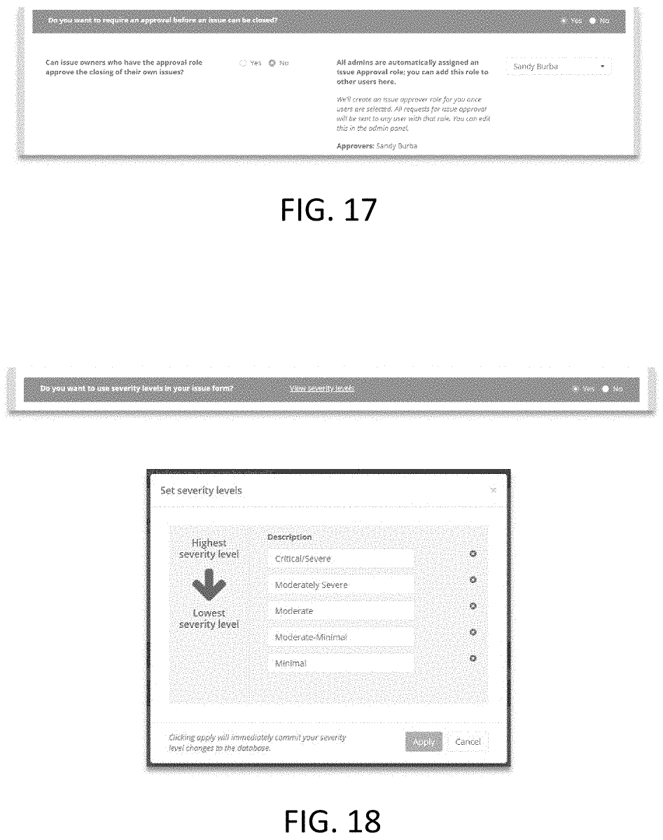

Approval for issues to be closed. A client may determine if they want to allow one or more issues (e.g., a problem or question regarding one or more vendors) to be closed with or without approval. If a client (e.g., a user) elects to use the approval setting, the client (e.g., an administrative user) may be required to identify which of their users can approve an issue. Administrator users may be provided with this capability by default. A client (e.g., an administrative user) may also be required to identify if a user who can approve an issue will be able to approve on their own or if additional approvals may be required. An example Issue Form: Approvals GUI is shown in FIG. 17.

Severity Levels. If a client (user) elects to have severity levels associated with their issues, they may have at minimum of two (2) but no more than five (5) levels, e.g., as shown in the Issue Form: Severity Levels GUI shown in FIG. 18.

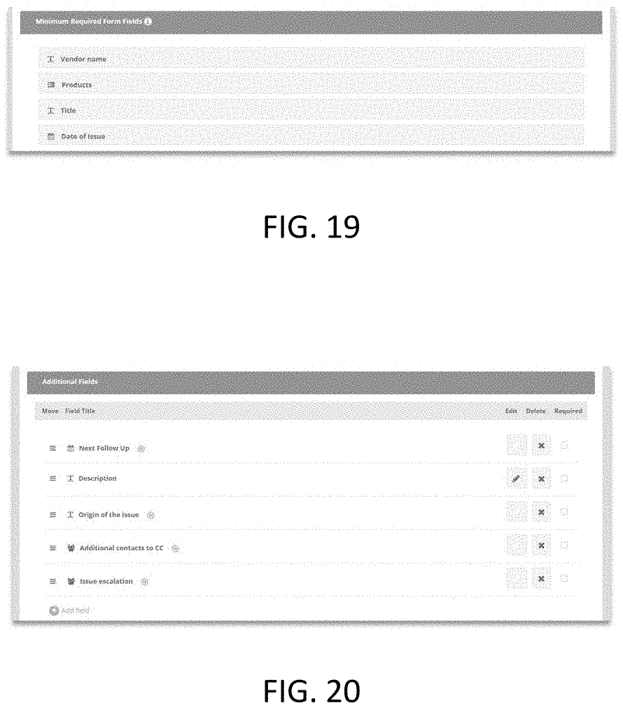

Form Fields. In some embodiments, a user may be provided with a set of fields that the provided system software requires by default for every client's issue form. An example Issue Form: Minimum Required Fields GUI is shown in FIG. 19

In some embodiments, other suggested fields that the system software (e.g., system 100) provides may be elected or discarded by a client user. An example Issue Form: Suggested Fields GUI is shown in FIG. 20.

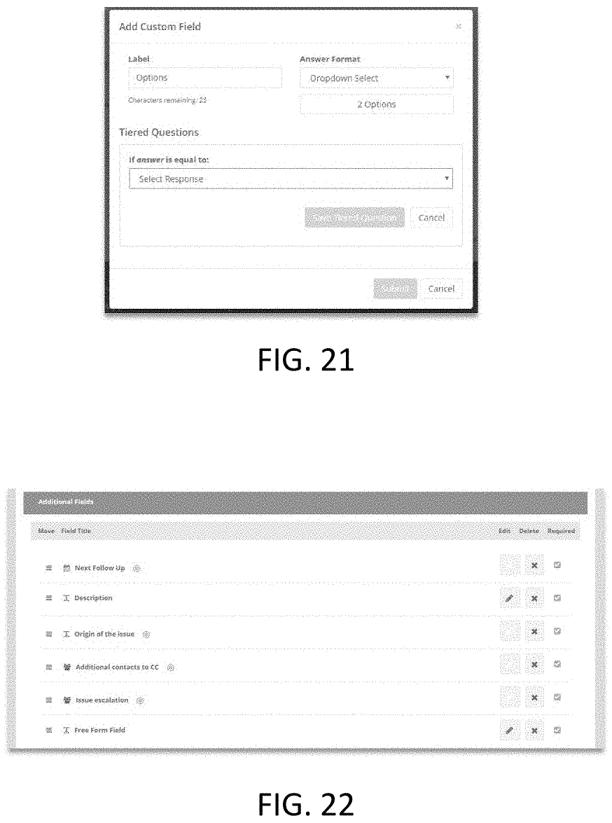

In some embodiments, a system software may allow a client user to create custom fields that include the ability to create tiered questions based on the response selected. An example Issue Form: Custom Field GUI is shown in FIG. 21.

In some embodiments, a client (user) may configure and manage their custom fields as well as some of the fields suggested automatically by the provided system. The system software may offers additional issue fields to be moved, edited, deleted, and marked as required. An example Issue Form: Additional Field Management GUI is shown in FIG. 22.

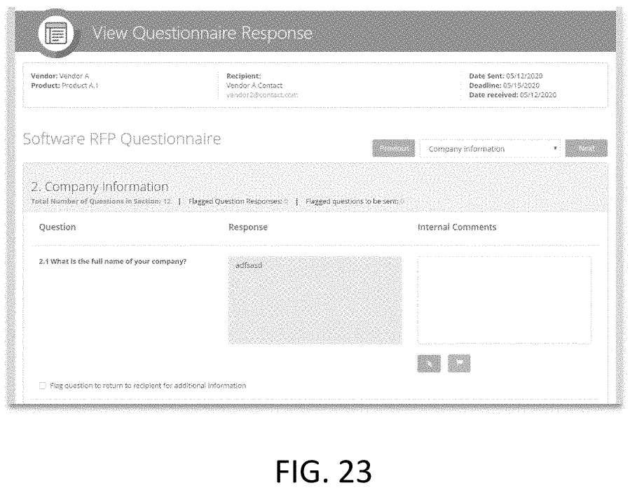

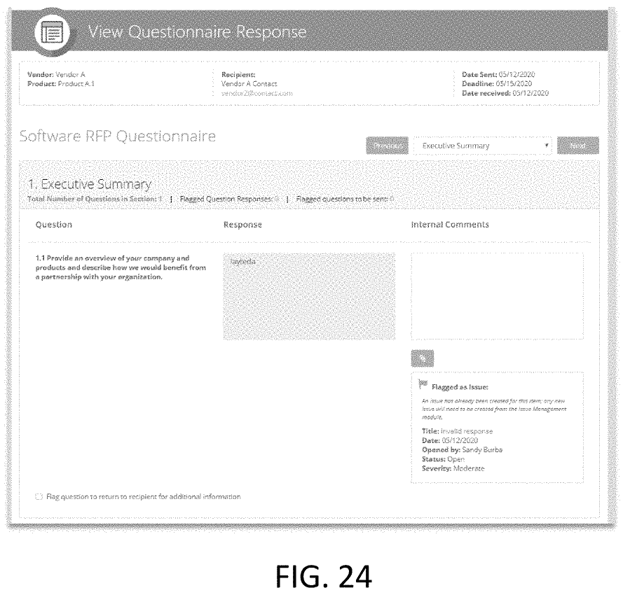

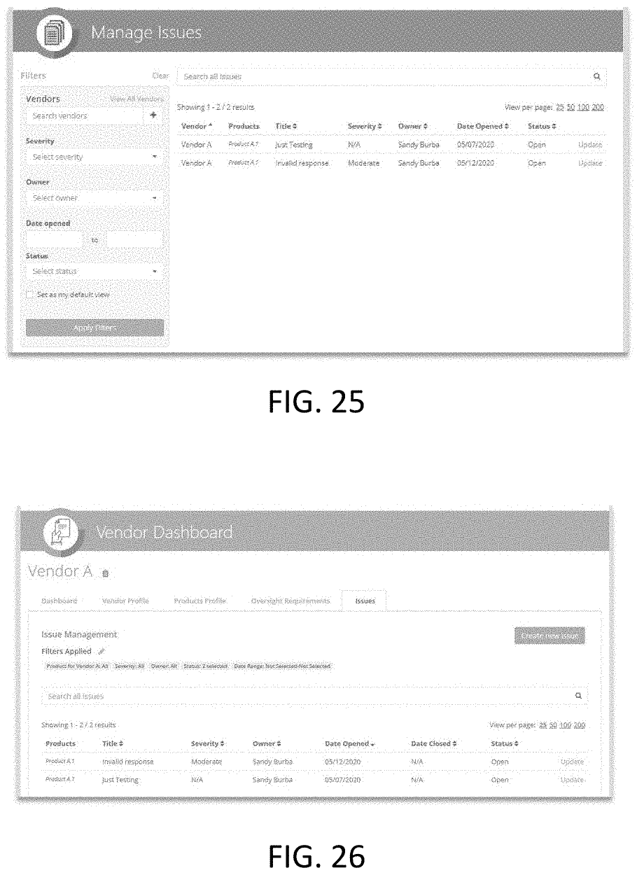

Issue Integration. Questionnaires. One or more issues (e.g., issue-related files or programs) may be opened and managed from within the issue management module or from a vendor dashboard. An example system as described herein may provide integration of issue management with a questionnaires module. This means that a client user who has both an issue management module and a questionnaire module within their purchase plan may be provided the capability to create an issue from a questionnaire that has a recipient response, for example, by linking the issue to a specific question within a questionnaire. An example Questionnaire Responses: Open an Issue GUI is shown in FIG. 23. In some embodiments, a client user may be provided with the capabilities to open an issue at the question level using the flag button. An example Questionnaire Responses: Open an Issue GUI with a flagged issue is shown in FIG. 24. An example Issue Management Module: Manage Issues GUI is shown in FIG. 25.

In some embodiments, after an issue is identified at the question level, a client user may be presented with the issue within the questionnaire as well as within the issue management module and the corresponding vendor's vendor dashboard. An example Vendor Dashboard: Issues GUI is shown in FIG. 26.

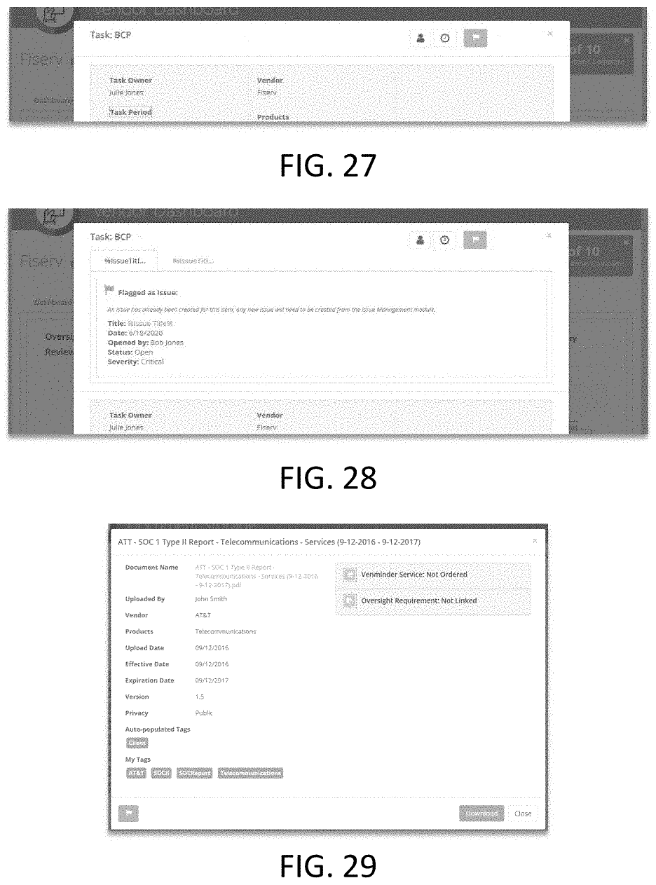

Oversight Tasks. In some embodiments, a user may be provided with the capability to open and manage issues at the oversight task level. An example Oversight Task: Create an Issue using flag GUI is shown in FIG. 27. An example Oversight Task: Issue Associated GUI is shown in FIG. 28.

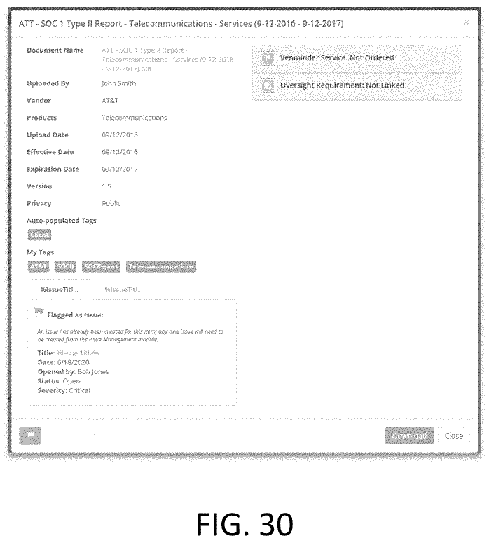

Documents. In some embodiments, a user may be provided with the capability to open and manage issues for documents located in a document storage module. An example Document: Create an Issue using flag GUI is shown in FIG. 29. An example Document: Issue Associated GUI is shown in FIG. 30.

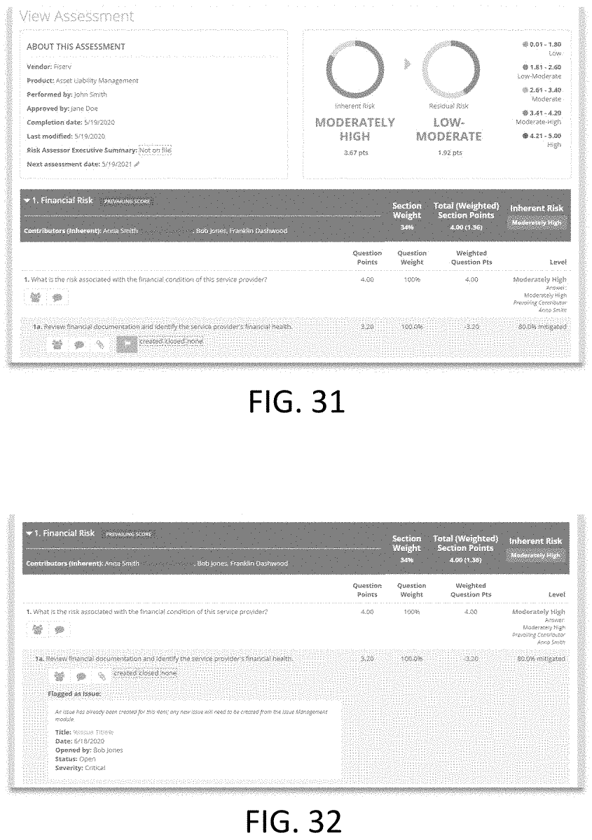

Assessments. In some embodiments, a client with access to both an issue management module and an advanced assessments module according to their purchase plan may be provided with the capability to create an issue from the residual risk area of a completed advanced risk assessment, for example, by linking the issue to a specific question within an assessment. An example Assessment: Create an Issue using flag GUI is shown in FIG. 31. An example Assessment: Issue Associated GUI is shown in FIG. 32.

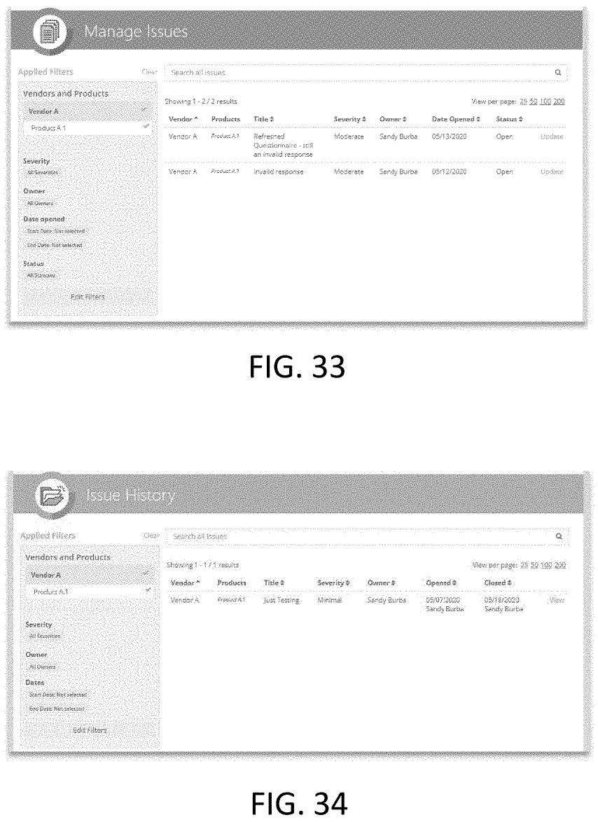

Issue Management. In some embodiments, issues that are in progress (for example, open or pending approval) may be stored in and/or accessed through the manage issues area of the issue management module. Issues may be updated, marked as closed and/or approved from this location. An example Issue Management: Manage Issues GUI is shown in FIG. 33.

Issue History. In some embodiments, issues that have been closed may be stored in the issue history area. Closed issues may be reopened when viewing the details of the issue. An example Issue Management: Manage Issues GUI is shown in FIG. 34.

Communications. In some embodiments, a system may provide or generate and send automatically one or more emails associated with the issue management module when applicable. An example list of emails and their triggers are listed in Table 5.

TABLE 5

| Email Template | Description | Trigger |
|---|---|---|
| Issue Created | Sent to any user identified for the issue | Issue Created |
| | created for fields that are in use on the | |
| | issue form but not issue owner. | |
| | Follow-up Owner | |
| | Additional contacts to CC | |
| | Issue Escalation | |
| Issue Updated | Sent to the users assigned to the issue based | Save issue |
| | on their involvement as selected by the user | |
| | editing the issue. | |
| Issue Approval | Applicable when approvals are required | Issue submitted for |
| Requested | to close an issue | approval |
| | Sent to all active and enrolled users with | |
| | the Issue Approver Role | |
| Issue Approval | Applicable when approvals are required | Send Approval |
| Reminder | to close an issue and issue has been | Reminder |
| | submitted for approval | |
| | Sent to all active and enrolled users with | |
| | the Issue Approver Role | |
| Issue Approved | Applicable when approvals are required | Issue Approved |
| | to close an issue and issue was | |
| | submitted for approval | |
| | Sent to issue owner | |
| Issue Not Approved | Applicable when approvals are required | Issue Not Approved |
| | to close an issue and issue was | |
| | submitted for approval | |
| | Sent to issue owner | |
| Issue Reopened | Sent to any user identified for the issue | Issue reopened |
| | created for fields that are in use on the | |
| | issue form but not the user who reopened | |
| | the issue. | |
| | Follow-up Owner | |
| | Additional contacts to CC | |
| | Issue Escalation | |
| Issue Follow-up | Applicable when Follow up is being | Sent on Follow up |
| Reminder | used on Issue Form | date identified in the |
| | Sent to user identified as Follow up | issue |
| | Owner | |
| Issue Closed (approval | Sent to issue owner | Issue closed |
| not required) | | |

Issue Reporting. In some embodiments, the system software may provide a client user with issue management reporting capabilities to aggregate issue data.

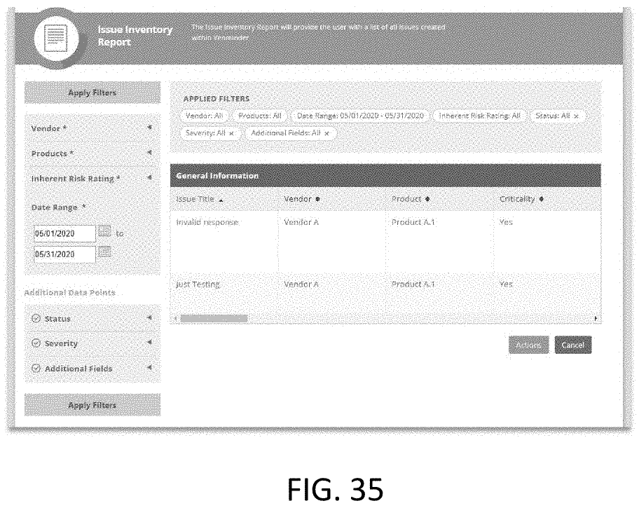

Issue Inventory. In some embodiments, the system may generate a data report that provides a user with a list of all issues created within the system. An example Issue Inventory Report GUI is shown in FIG. 35.

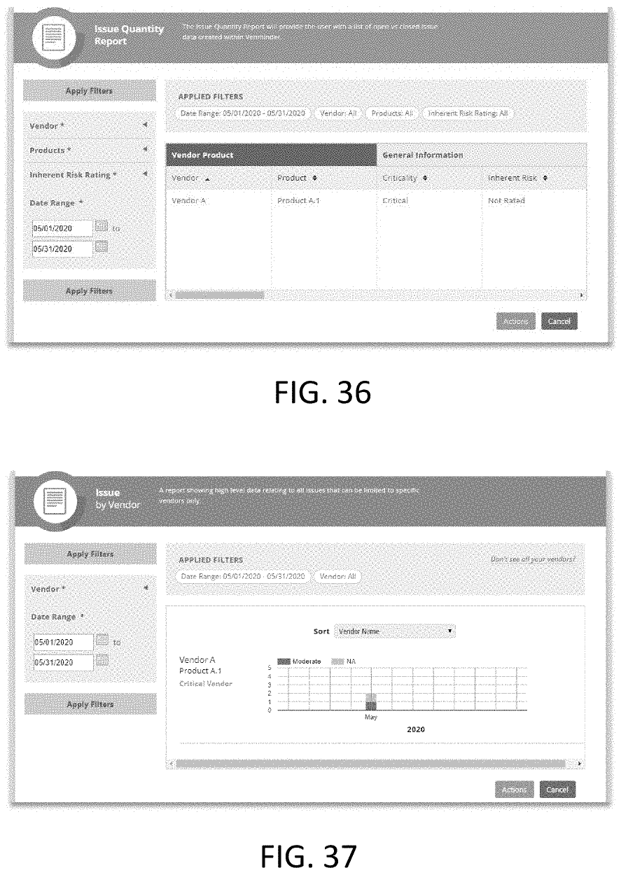

Issue Quantity. In some embodiments, the system may generate a data report that provides the user with a list of open vs. closed issue data created within the system. An example Issue Quantity Report GUI is shown in FIG. 36.

Issue by Vendor. In some embodiments, the system may generate a visual report showing high level data relating to all issues that can be limited to specific vendors only. An example Issue by Vendor GUI is shown in FIG. 37.

Exemplary Network Environment and Computing Device

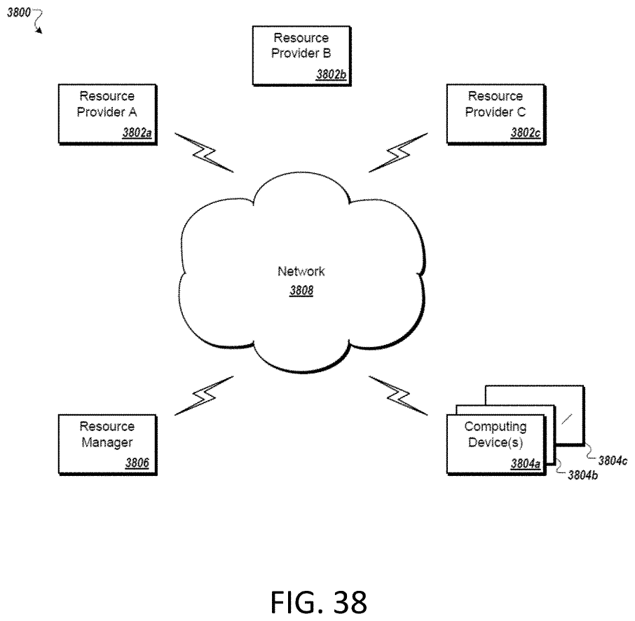

FIG. 38 shows an illustrative network environment 3800 for use in the methods and systems described herein. In brief overview, referring now to FIG. 38, a block diagram of an exemplary cloud computing environment 3800 is shown and described. The cloud computing environment 3800 may include one or more resource providers 3802a, 3802b, 3802c (collectively, 3802). Each resource provider 3802 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 3802 may be connected to any other resource provider 3802 in the cloud computing environment 3800. In some implementations, the resource providers 3802 may be connected over a computer network 3808. Each resource provider 3802 may be connected to one or more computing device 3804a, 3804b, 3804c (collectively, 3804), over the computer network 3808.

The cloud computing environment 3800 may include a resource manager 3806. The resource manager 3806 may be connected to the resource providers 3802 and the computing devices 3804 over the computer network 3808. In some implementations, the resource manager 3806 may facilitate the provision of computing resources by one or more resource providers 3802 to one or more computing devices 3804. The resource manager 3806 may receive a request for a computing resource from a particular computing device 3804. The resource manager 3806 may identify one or more resource providers 3802 capable of providing the computing resource requested by the computing device 3804. The resource manager 3806 may select a resource provider 3802 to provide the computing resource. The resource manager 3806 may facilitate a connection between the resource provider 3802 and a particular computing device 3804. In some implementations, the resource manager 3806 may establish a connection between a particular resource provider 3802 and a particular computing device 3804. In some implementations, the resource manager 3806 may redirect a particular computing device 3804 to a particular resource provider 3802 with the requested computing resource.

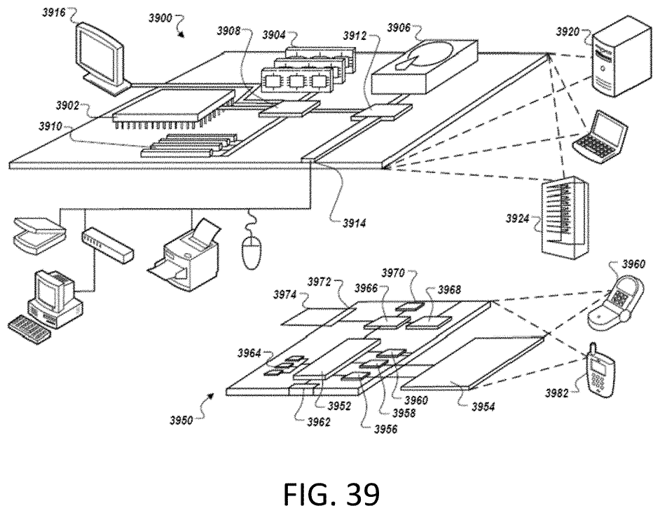

FIG. 39 shows an example of a computing device 3900 and a mobile computing device 3950 that can be used in the methods and systems described in this disclosure. The computing device 3900 is intended to represent various forms of digital computers, such as laptops, desktops, workstations, personal digital assistants, servers, blade servers, mainframes, and other appropriate computers. The mobile computing device 3950 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 3900 includes a processor 3902, a memory 3904, a storage device 3906, a high-speed interface 3908 connecting to the memory 3904 and multiple high-speed expansion ports 3910, and a low-speed interface 3912 connecting to a low-speed expansion port 3914 and the storage device 3906. Each of the processor 3902, the memory 3904, the storage device 3906, the high-speed interface 3908, the high-speed expansion ports 3910, and the low-speed interface 3912, are interconnected using various busses, and may be mounted on a common motherboard or in other manners as appropriate. The processor 3902 can process instructions for execution within the computing device 3900, including instructions stored in the memory 3904 or on the storage device 3906 to display graphical information for a GUI on an external input/output device, such as a display 3916 coupled to the high-speed interface 3908. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 3904 stores information within the computing device 3900. In some implementations, the memory 3904 is a volatile memory unit or units. In some implementations, the memory 3904 is a non-volatile memory unit or units. The memory 3904 may also be another form of computer-readable medium, such as a magnetic or optical disk.

The storage device 3906 is capable of providing mass storage for the computing device 3900. In some implementations, the storage device 3906 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 3902), perform one or more methods, such as those described above. The instructions can also be stored by one or more storage devices such as computer- or machine-readable mediums (for example, the memory 3904, the storage device 3906, or memory on the processor 3902).

The high-speed interface 3908 manages bandwidth-intensive operations for the computing device 3900, while the low-speed interface 3912 manages lower bandwidth-intensive operations. Such allocation of functions is an example only. In some implementations, the high-speed interface 3908 is coupled to the memory 3904, the display 3916 (e.g., through a graphics processor or accelerator), and to the high-speed expansion ports 3910, which may accept various expansion cards (not shown). In the implementation, the low-speed interface 3912 is coupled to the storage device 3906 and the low-speed expansion port 3914. The low-speed expansion port 3914, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 3900 may be implemented in a number of different forms, as shown in the figure. For example, it may be implemented as a standard server 3920, or multiple times in a group of such servers. In addition, it may be implemented in a personal computer such as a laptop computer 3922. It may also be implemented as part of a rack server system 3924. Alternatively, components from the computing device 3900 may be combined with other components in a mobile device (not shown), such as a mobile computing device 3950. Each of such devices may contain one or more of the computing device 3900 and the mobile computing device 3950, and an entire system may be made up of multiple computing devices communicating with each other.

The mobile computing device 3950 includes a processor 3952, a memory 3964, an input/output device such as a display 3954, a communication interface 3966, and a transceiver 3968, among other components. The mobile computing device 3950 may also be provided with a storage device, such as a micro-drive or other device, to provide additional storage. Each of the processor 3952, the memory 3964, the display 3954, the communication interface 3966, and the transceiver 3968, are interconnected using various buses, and several of the components may be mounted on a common motherboard or in other manners as appropriate.

The processor 3952 can execute instructions within the mobile computing device 3950, including instructions stored in the memory 3964. The processor 3952 may be implemented as a chipset of chips that include separate and multiple analog and digital processors. The processor 3952 may provide, for example, for coordination of the other components of the mobile computing device 3950, such as control of user interfaces, applications run by the mobile computing device 3950, and wireless communication by the mobile computing device 3950.

The processor 3952 may communicate with a user through a control interface 3958 and a display interface 3956 coupled to the display 3954. The display 3954 may be, for example, a TFT (Thin-Film-Transistor Liquid Crystal Display) display or an OLED (Organic Light Emitting Diode) display, or other appropriate display technology. The display interface 3956 may comprise appropriate circuitry for driving the display 3954 to present graphical and other information to a user. The control interface 3958 may receive commands from a user and convert them for submission to the processor 3952. In addition, an external interface 3962 may provide communication with the processor 3952, so as to enable near area communication of the mobile computing device 3950 with other devices. The external interface 3962 may provide, for example, for wired communication in some implementations, or for wireless communication in other implementations, and multiple interfaces may also be used.

The memory 3964 stores information within the mobile computing device 3950. The memory 3964 can be implemented as one or more of a computer-readable medium or media, a volatile memory unit or units, or a non-volatile memory unit or units. An expansion memory 3974 may also be provided and connected to the mobile computing device 3950 through an expansion interface 3972, which may include, for example, a SIMM (Single In Line Memory Module) card interface. The expansion memory 3974 may provide extra storage space for the mobile computing device 3950, or may also store applications or other information for the mobile computing device 3950. Specifically, the expansion memory 3974 may include instructions to carry out or supplement the processes described above, and may include secure information also. Thus, for example, the expansion memory 3974 may be provided as a security module for the mobile computing device 3950, and may be programmed with instructions that permit secure use of the mobile computing device 3950. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 3952), perform one or more methods, such as those described above. The instructions can also be stored by one or more storage devices, such as one or more computer- or machine-readable mediums (for example, the memory 3964, the expansion memory 3974, or memory on the processor 3952). In some implementations, the instructions can be received in a propagated signal, for example, over the transceiver 3968 or the external interface 3962.

The mobile computing device 3950 may communicate wirelessly through the communication interface 3966, which may include digital signal processing circuitry where necessary. The communication interface 3966 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 3968 using a radio-frequency. In addition, short-range communication may occur, such as using a Bluetooth®, Wi-Fi™, or other such transceiver (not shown). In addition, a GPS (Global Positioning System) receiver module 3970 may provide additional navigation- and location-related wireless data to the mobile computing device 3950, which may be used as appropriate by applications running on the mobile computing device 3950.

The mobile computing device 3950 may also communicate audibly using an audio codec 3960, which may receive spoken information from a user and convert it to usable digital information. The audio codec 3960 may likewise generate audible sound for a user, such as through a speaker, e.g., in a handset of the mobile computing device 3950. Such sound may include sound from voice telephone calls, may include recorded sound (e.g., voice messages, music files, etc.) and may also include sound generated by applications operating on the mobile computing device 3950.

The mobile computing device 3950 may be implemented in a number of different forms, as shown in the figure. For example, it may be implemented as a cellular telephone 3980. It may also be implemented as part of a smart-phone 3982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A method for managing one or more vendors and/or products, the method comprising the steps of:
causing to display, by a processor of an enterprise system, one or more graphical user interfaces (GUIs) associated with one or more issue management modules;
receiving, by the processor of the enterprise system, a first input from a first client user, the first input comprising instructions to access an issue form;
receiving, by the processor of the enterprise system, data field information related to at least one of the vendor and the product; and
updating, in a memory of the enterprise system, at least one of vendor information and product information stored in association with the first client user, based on a subsequent input;
wherein the issue management module is configured to track or monitor unplanned or planned events that arise with a vendor.

2. The method of claim 1, wherein the subsequent input comprises data field information requesting approval of closure of an issue.

3. The method of claim 1, wherein the subsequent input comprises custom data field information related to issue severity.

4. The method of claim 1, wherein the subsequent input comprises custom data field information related to selectable form fields or custom form fields.

5. The method of claim 1, wherein the first input comprises instructions to access an issue form via a questionnaire module or a vendor dashboard.

6. The method of claim 1, wherein the first input comprises instructions to access an issue form via a residual risk module.

7. The method of claim 1, wherein the subsequent input comprises a request to display a manage issues graphical user interface (GUI) or an issue history GUI.

8. The method of claim 1, wherein the system is configured to generate and send one or more email communications upon receipt of one or more triggers.

9. The method of claim 1, wherein the first input is received via a graphical user interface widget.

10. The method of claim 1, wherein the first client user has been authorized to access the enterprise system.

11. The method of claim 10, wherein the first client user comprises one member of a network of subscribed clients.

12. The method of claim 1, wherein receiving by the processor of the enterprise system comprises receiving via a graphical user interface widget.
